(19) United States
(12) Patent Application Publication
(10) Pub. No.: US 2008/0105622 A1
(43) Pub. Date: May 8, 2008

(54) COATED GAS BUBBLES FOR RECOVERY OF HYDROCARBON

(75) Inventors: KEVIN MORAN, Edmonton (CA); JAN CZARNECKI, Edmonton (CA)

Correspondence Address: BENNETT JONES;C/O MS ROSEANN CALDWELL, 4500 BANKERS HALL EAST, 855 - 2ND STREET, SW, CALGARY, AB, T2P 4K7, CA

(73) Assignee: SYNCRUDE CANADA LTD. in trust for the owners of the Syncrude Project, Fort McMurray (CA)

(21) Appl. No.: 11/850,533

(22) Filed: Sep. 5, 2007

Related U.S. Application Data
(60) Provisional application No. 60/825,631, filed on Sep. 14, 2006.

(51) Int. Cl. B32B 1/00; B05D 1/18; B01D 35/00; B03D 1/02

(52) U.S. Cl. 210/705; 427/430.1; 210/704; 210/205; 428/403

(57) ABSTRACT

A coated gas bubble for recovering oil from oil-containing samples is provided, comprising a gas bubble and a coating mixture comprising a hydrophobic coating agent and a coating promoting additive, wherein the coating promoting additive is present in an amount sufficient to promote the substantially continuous coating of the gas bubble with the hydrophobic coating agent. A method for forming such coated gas bubbles and a method for recovering oil from oil-containing samples using coated gas bubbles is further provided.

### FIELD OF THE INVENTION

The present invention relates to unique coated gas bubbles and a method for forming coated gas bubbles using a hydrophobic coating agent such as a hydrocarbon and a coating promoting additive. Further, the present invention relates to a method and system for recovering oil from oil-containing samples using coated gas bubbles, and, more specifically, for recovering bitumen from an aqueous oil sand slurry, using hydrocarbon coated gas bubbles.

### BACKGROUND OF THE INVENTION

The demand for petroleum and petroleum derivatives has been steadily growing throughout the world over the last few decades. Because of this growing demand, processes used for the extraction of petroleum and petroleum derivatives from various naturally-occurring reservoirs have had to become increasingly more sophisticated. However, some reservoirs present various challenges to the efficient extraction of petroleum. For example, the naturally-occurring geological formations known as tar sands or oil sands have posed interesting challenges. Oil sands have been found throughout the world, but the largest deposits have been found to lie in northern Alberta (Canada) along the Athabasca River. In this region of northern Alberta, oil sands have been estimated to be more than 60 meters thick, and to occupy over a total area of approximately 50,000 square kilometers.

Oil sand, such as is mined in the Fort McMurray region of Alberta, generally comprises water-wet sand grains held together by a matrix of viscous bitumen. It lends itself to liberation of the sand grains from the bitumen, preferably by slurrying the oil sand in heated process water, allowing the bitumen to move to the aqueous phase. The oil sand slurry thus formed is further conditioned, for example, in a pipeline, so that the bitumen coalesces and attaches to air bubbles, thereby forming a bitumen froth that can be separated from the sand in a separator such as a gravity separator or cyclonic separator.

The bitumen froth that is produced from oil sands routinely contains about 20-40% by volume dispersed water in which colloidal clay particles are well dispersed. Such an oil-water mixture is very stable and very viscous, having viscosities even higher than the oil alone. Further, the bitumen froth is non-conducting and the density of the bitumen is nearly identical to the density of the water.

However, in many cases, problems with the attachment of bitumen to air bubbles have been encountered, which have resulted in dramatically increased costs and decreased efficiency. At times, the efficiency of attachment to the air bubbles is very low, or the attachment has been hindered because of inherent physico-chemical properties of the oil sands ores or of the water slurry where oil sands conditioning occurs.

To date, several different proposals have been made in an attempt to resolve the problems encountered with bitumen aeration. Bitumen recovery may be enhanced by improving the conditioning of bitumen, that is, more specifically, by improving the aeration of dispersed bitumen droplets. One proposed process involved the use of caustic and hot water or steam. However, this process is fraught with many disadvantages, including inefficient recovery of petroleum from the oil sands, and complicated disposal of the slurried materials due to their highly caustic nature.

Another proposed process for bitumen recovery from oil sands involved the use of heat to drive the bitumen out of the oil sand. However, this process is not efficient and requires large amounts of energy, which results in prohibitively high operating costs.

Canadian Patent Application No. 2,421,474 proposes the use of “oily bubbles”, in particular, air bubbles coated with a hydrocarbon, to enhance bitumen recovery from oil sands by enhancing air-bitumen attachment, and thereby improving bitumen flotation and bitumen recovery. A hydrocarbon such as kerosene is heated to a vaporization temperature of 200° C. in an incompressible container, mixed with a gas such as air, and injected into aqueous oil sand slurries. It is proposed that the “oily bubbles” can attach to bitumen, and form bitumen froth that floats to the top of the aqueous slurry, where the bitumen froth can be easily recovered.

It was discovered, however, that the process disclosed in Canadian Patent Application No. 2,421,474 for making these “oily bubbles” does not result in the formation of true “oily bubbles”. In particular, the hydrocarbon, e.g., kerosene, naphtha, diesel and other common industrial oils, does not completely coat the air bubble, but instead appears to “ball up” at an air bubble surface due to thermodynamic limitations. The inability of the hydrocarbon to completely coat the air bubble significantly reduces an air bubble's ability to preferentially attach to and entrain significant amounts of bitumen and results in low extraction efficiency.

Second, the heating of a hydrocarbon such as kerosene to high temperature can be quite dangerous and result in fire and/or explosion. Moreover, the manner in which the hydrocarbon is vaporized according to Canadian Patent Application No. 2,421,474 results in inefficient vaporization, as kerosene, and other oils of industrial import, is only partially vaporized at 200° C.

Consequently, there is a need for an improved method and system for recovering bitumen from aqueous oil sand slurries easily and efficiently that allows for higher recovery and better quality.

### SUMMARY OF THE INVENTION

In one broad aspect of the invention, a coated gas bubble for recovering oil from oil-containing samples is provided, comprising:
a gas bubble; and
a coating mixture comprising a hydrophobic coating agent and a coating promoting additive;
   whereby the coating promoting additive is present in an amount sufficient to promote the substantially continuous coating of the gas bubble with the hydrophobic coating agent.

In another broad aspect of the invention, a method is provided for forming gas bubbles coated with a hydrophobic coating agent in an aqueous environment, including:
providing a gas stream;
injecting the hydrophobic coating agent and a coating promoting additive into the gas stream to form an air, hydrophobic coating agent and coating promoting additive mixture; and
introducing the mixture into the aqueous environment and forming the coated gas bubbles.

In one embodiment, the mixture is introduced into the aqueous environment by means of an atomizer. For example, a suitable atomizer includes a nozzle, syringe, perforated pipe or other such diffuser.

The aqueous environment could be any aqueous oil-containing samples. Preferably, the aqueous environment is a bitumen-containing aqueous oil sand slurry.

The hydrophobic coating agent of the present invention may be a hydrocarbon such as kerosene, diesel, naphtha, and the like. It is understood, however, that any low-viscosity, water-immiscible liquid having some degree of solubility for oil such as bitumen can be used, for example, an inorganic or polymer agent that acts as a hydrocarbon.

The addition of a coating promoting additive of the present invention causes the hydrophobic coating agent to spontaneously spread at the gas-water interface, thereby providing substantially complete coverage of the gas bubble. The substantially uniform coating of the gas bubble with the hydrophobic coating agent increases the attraction of the gas bubble to hydrophobic molecules such as oil or bitumen, allowing for the separation of the oil or bitumen via flotation. In one embodiment, the coating promoting additive is an oil soluble additive such as a surfactant. Preferably, the surfactant has a lower hydrophile-lipophile balance (HLB), preferably less than 9. It is believed that the addition of a lower HLB surfactant (also referred to as a lipophilic surfactant) results in smaller bubbles forming due to the reduction of the interfacial tension between the hydrocarbon coating agent and the forming gas bubbles.

Without being limiting, examples of surfactants having low HLB values include beeswax, lanolin, ethylene glycol monostearate, surfactants based on condensates of fatty acids with ethylene glycol or diethylene glycol, high molecular weight naphthenic acids, sorbitan tristearate, methyl isobutyl carbonyl, ethoxylated alkyl phenols, alkyl and alkylaryl sulfonic acid salts, and polyoxyethylene ether 2 stearyl ether. See McCutcheon's Detergents & Emulsifiers, 1977 Annual, pages 9-27 for a list of surfactants and their HLB values. It is understood that the surfactant can be a combination of two or more surfactants described in the foregoing. Mixtures which include surfactants having an HLB greater than 9, may also be used with the proviso the blend has an HLB value less than 9. In a preferred embodiment, the coating promoting additive is selected from the group consisting of polyoxyethylene Ether 2 Stearyl Ether (Brij® 72), Ethylenediamine tetrakis(propoxylate-block-ethoxylate) tetrol (Tetronic™ 701), Triton™ SP-135, and mixtures thereof.

In a preferred embodiment, the method for forming gas bubbles coated with a hydrophobic coating agent in an aqueous environment further comprises introducing steam into the gas stream. The addition of steam promotes the formation of coated gas bubbles that are of a relatively small size, due to latent heat condensation of the gas bubbles, and in a preferred embodiment a significant portion of the gas bubbles are less than 10 μm, preferably less than 1 μm. Furthermore, the addition of steam creates the appropriate atmosphere to drive the hydrophobic coating agent/coating promoting additive combination to the bubble surface. In another embodiment, steam is added directly to the gas stream either prior to or after the addition of the hydrophobic coating agent and coating promoting additive to the gas stream.

In one embodiment, the hydrophobic coating agent and the coating promoting additive are injected into the gas stream by means of an atomizing nozzle. Preferably, the coating promoting additive is dissolved in the hydrophobic coating agent prior to atomization. In another embodiment, the hydrophobic coating agent and the coating promoting additive are injected into the gas stream by means of a diesel injector. By atomizing the hydrophobic coating agent and the coating promoting additive in an atomizing nozzle or diesel injector prior to injection into the gas stream, one can avoid using high temperatures. Further, the use of an atomizer creates hydrophobic coating agent droplets of approximately 30 microns or less, facilitating the efficient transport of the hydrophobic coating agent and coating promoting additive to the bubble surface.

The coated gas bubbles of the present invention can be used to condition an aqueous oil sand slurry by promoting the attachment of the gas bubbles to the bitumen droplets in the slurry. For example, the coated gas bubbles may be injected into a pipeline transporting oil sand slurry to aid in the conditioning of the slurry therein. The coated gas bubbles, which are generally smaller in size, increase the contact efficiency of the bubbles with bitumen allowing the bitumen to be separated from the solids and water as bitumen froth.

In another broad aspect of the invention, a method for recovering oil from an oil-containing sample is provided, including,
introducing into the oil-containing sample a plurality of gas bubbles having a coating comprising a hydrophobic coating agent and a coating promoting additive;
allowing the oil to interact with the coated gas bubble to form an oil-gas bubble complex; and
separating the oil-gas bubble complex from the remainder of the sample to form an oily froth.

The coating promoting additive is present in an amount sufficient to promote the substantially continuous coating of the gas bubbles with the hydrophobic coating agent and reduce the interfacial tension between the hydrophobic coating agent and liquid contained in the oil-containing sample and the coated gas bubbles are introduced in a sufficient amount and at a sufficient rate to promote liberation and recovery of the oil from the oil-containing sample. The hydrophobic coating agent allows the gas bubble to attract the oil present in the oil-containing sample and promote recovery of an oily froth by flotation.

In another broad aspect, a system for recovering oil from an oil-containing sample is provided, the system including:
a container for housing the oil-containing sample;
a gas bubble generator for generating a plurality of gas bubbles having a coating, the coating comprising a hydrophobic coating agent and a coating promoting additive; and
means for introducing the plurality of coated gas bubbles into the container.

It is understood that both the method and system for recovering oil from an oil-containing sample according to the invention may be used to recover oil from a wide variety of different oil-containing sample. The term “oil-containing sample” can include any hydrocarbon-containing medium, for example, which is not meant to be limiting, geological samples such as tar sands, oil sands, oil sandstones, as well as any other naturally-occurring geologic materials having hydrocarbons contained within a generally porous rock-like inorganic matrix. Moreover, this term is also meant to include any hydrocarbon-containing process stream in a hydrocarbon extraction process containing bitumen or other petroleum-like hydrocarbons. These can include, but are not limited to, tailings and middlings process streams related to bitumen recovery from oil sands.

In one embodiment, the oil-containing sample is an aqueous oil sand slurry comprising heavy oil (bitumen), solids and water, wherein the bitumen interacts with the coated gas bubbles to form bitumen froth. The bitumen froth can then be separated from the solids and water, for example, in a gravity separator such as a primary separation vessel or PSV.

The use of both a hydrophobic coating agent and a coating promoting additive can be particularly advantageous in forming gas bubbles that have a substantially continuous coating. Without wishing to be bound by theory, the presence of a substantially continuous coating on the gas bubble can result in greater yields of recovered oil from oil-containing samples such as aqueous oil sand slurries. Currently, the available methods and processes cannot form gas bubbles having a substantially continuous coating, which result in disappointing yields.

The gas bubble generator, which will be discussed in greater detail below, can function to generate the plurality of coated gas bubbles, whose coating comprises a mixture of the hydrophobic coating agent and the coating promoting additive.

The coated gas bubbles formed according to the invention can be made from a wide variety of different gases. For example, which is not meant to be limiting, the gas bubbles may be formed from gas such as nitrogen or from air or other inert gases such as argon.

The hydrophobic coating agent that can be used according to the invention can take many different forms, and can include hydrocarbons, and inorganic and polymeric agents, and mixtures or combinations thereof. Advantageously, the hydrophobic coating agent should have low viscosity and have some degree of solubility for bitumen. In one embodiment, the hydrophobic coating agent can be selected from kerosene, diesel, and naphtha. In another embodiment, the hydrophobic coating agent can be kerosene.

As discussed above, when combined with the hydrophobic coating agent, the coating promoting additive can facilitate the substantially continuous coating of the gas bubbles by altering the state of the coating in such a way as to obtain favorable thermodynamic conditions, where the value of the spreading coefficient S is greater than zero. The coating promoting additive can be selected from a wide range of different compounds. Advantageously, the coating promoting additive is a compound that can reduce the interfacial tension between the hydrophobic coating agent and the water in the aqueous slurry.

Further, it may also be advantageous that the coating promoting additive be capable of increasing the fluid viscosity at the gas bubble surface, thus retarding the coalescence of the gas bubbles. Varying amounts of the coating promoting additive can be used. In one embodiment, approximately 10 to approximately 1000 ppm of a coating promoting additive can be used. In a preferred embodiment, a minimum concentration of approximately 50 ppm of polyoxyethylene ether 2 stearyl ether (Brij® 72) can be used. In another preferred embodiment, a minimum concentration of about 10 ppm of either Ethylenediamine tetrakis(propoxylate-block-ethoxylate) tetrol (Tetronic™ 701) or Triton™ SP-135 can be used.

In one embodiment, the hydrophobic coating agent [with or without the coating promoting additive dissolved therein] is introduced into a gas stream, preferably at a concentration of about 500 ppm to about 1500 based on volume. Addition of coated bubbles of the present invention at a rate of about 200 mL/min can process or condition approximately 1 to 3 kg of oil sand slurry.

### BRIEF DESCRIPTION OF THE DRAWINGS

The present invention, both as to its organization and manner of operation, may best be understood by reference to the following description, and the accompanying drawings of various embodiments wherein like reference numerals are used throughout the several views, and in which:

FIGS. 1a, 1b and 1c are photomicrographs showing air bubble size when air alone is injected into a column of water.

FIGS. 2a, 2b and 2c are photomicrographs of a column of water showing the effect of the addition of atomized kerosene to air prior to injection into a column of water.

FIGS. 3a, 3b and 3c are photomicrographs of a column of water showing the effect of the addition of an atomized kerosene and polyoxyethylene ether 2 stearyl ether (Brij® 72) mixture to air prior to injection into a column of water.

FIGS. 4a and 4b, respectively, show two water columns into which air only is injected (2a) and air plus steam is injected (4b).

FIG. 5 is a schematic of an experimental test skid used to produce and test coated bubbles of the present invention.

FIG. 6 is a graph showing percent bitumen recovery from aqueous oil sand slurry when coated gas bubbles of the present invention are used.

FIG. 7 is a graph showing the influence of Brij® 72 on interfacial tensions and spreading of kerosene onto a water surface.

FIG. 8 is a graph showing the influence of Tetronic™ 701 on interfacial tensions and spreading of kerosene onto a water surface.

FIG. 9 is a graph showing the influence of Triton™ SP-135 on interfacial tensions and spreading of kerosene onto a water surface.

FIG. 10 is a graph showing the spreading kinetics of kerosene treated with various concentrations of Brij® 72.

FIG. 11 is a graph showing the spreading kinetics of kerosene treated with various concentrations of Tetronic™ 701.

FIG. 12 is a graph showing the spreading kinetics of kerosene treated with various concentrations of Triton™ SP-135.

### DESCRIPTION OF THE PREFERRED EMBODIMENTS

An embodiment of the present invention will now be described using kerosene as an example of a suitable hydrophobic coating agent and polyoxyethylene ether 2 stearyl ether (Brij® 72) as a suitable coating promoting additive. It is understood that other hydrophobic coating agents could be used, for example, Tetronic™ 701 and Triton™ SP-135.

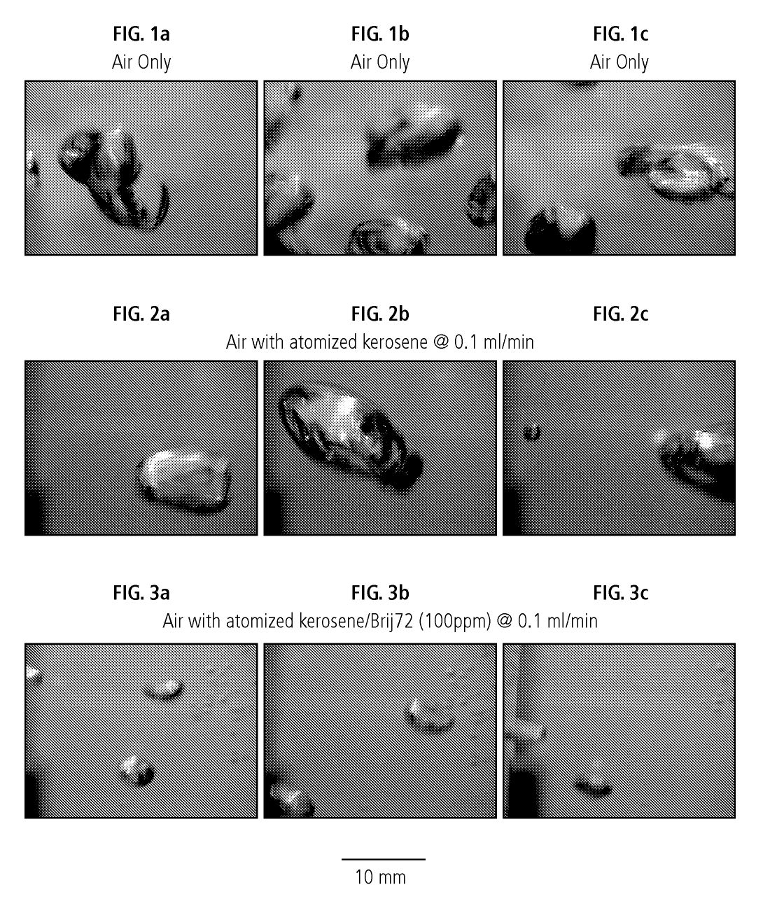

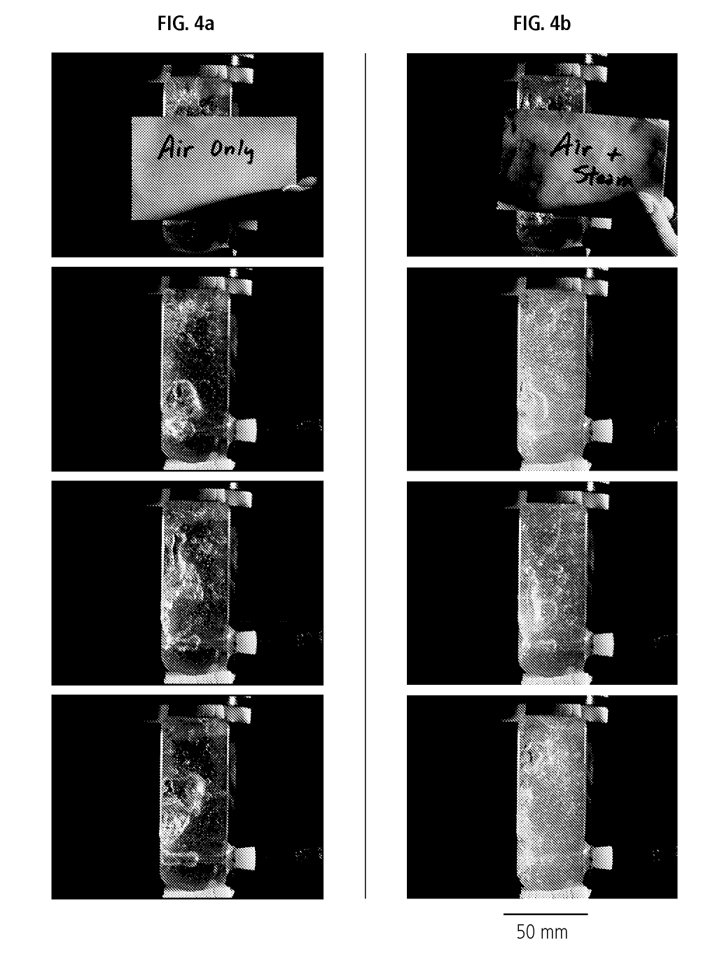

The effect of the injection of an air stream only, an air stream comprising atomized kerosene, and an air stream comprising atomized kerosene/Brij® 72 (100 ppm) mixture of the present invention into a column of water can be seen in FIGS. 1a, 1b and 1c, FIGS. 2a, 2b and 2c, and FIGS. 3a, 3b and 3c, respectively.

FIGS. 1a, 1b and 1c are representative photomicrographs of a water column after injection of air only. It can be seen that air bubble size is on average 10 mm or greater in its longest dimension. FIGS. 2a, 2b and 2c are representative photomicrographs of a water column when air and atomized kerosene is injected into the column. Kerosene was added to the air stream at a rate of about 0.1 mL/min prior to injection into the column. It can be seen that the addition of atomized kerosene has a marginal effect on the air bubble size, likely due to the fact that the kerosene “balls up” on the air bubble surface, and the air bubbles so produced are on average as large as when air alone is injected.

However, as shown in FIGS. 3a, 3b and 3c, when Brij 72 was dissolved at 100 ppm in kerosene and the kerosene/Brij® 72 mixture was atomized and added to the air stream at a rate of 0.1 mL/min, the size of the air bubbles so produced was markedly reduced averaging about 5 mm or less. Thus, the addition of a mixture of a hydrophobic coating agent and a coating promoting additive of the present invention greatly reduces the size of the air bubbles. Smaller bubbles are thought to be beneficial for mineral flotation as practiced, for example, in the oil sands industry.

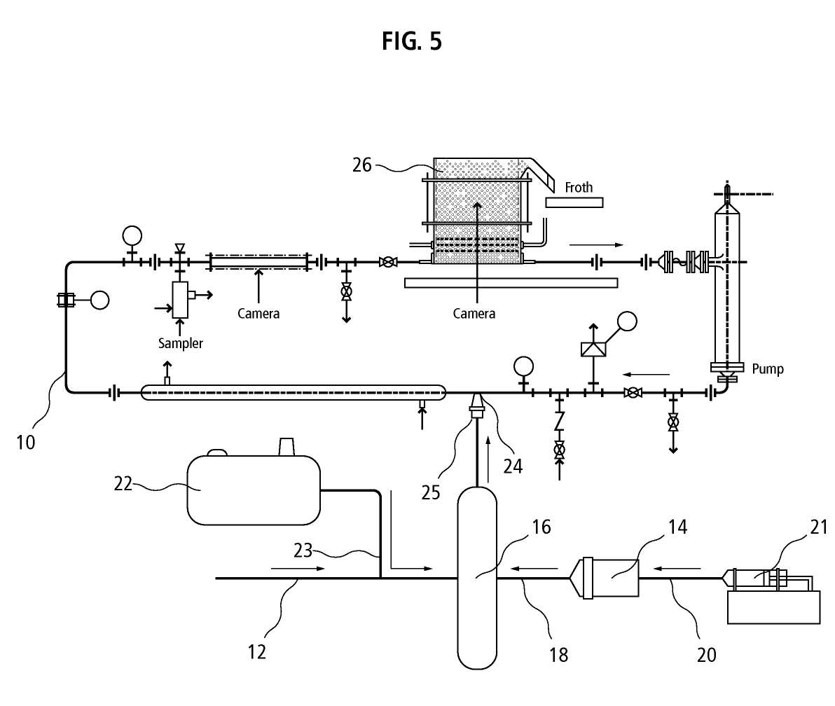

FIG. 5 is a schematic of an experimental test system used to produce and test the effectiveness of the coated bubbles of the present invention to produce bitumen froth from an oil sand slurry. As shown in FIG. 5, a kerosene and Brij® 72 mixture 20 is pumped into an atomizer 14 where the mixture is atomized. The atomized mixture 18 is thus introduced into gas bubble generator vessel 16. By atomizing the kerosene/Brij® 72 mixture first, the full volume of kerosene may be introduced into the gas bubble generator vessel 16 as approximately 30 micron droplets at closer to ambient temperatures, which can avoid any explosive hazards associated with heating a volatile solvent. Devices which can be used to atomize the mixture include, but are not limited to, an atomization nozzle, nebulizers, injectors, and/or evaporators. In one embodiment, a diesel injector may be used for this step.

Pressurized air 12 is also introduced into the gas bubble generator vessel 16 where it contacts the atomized mixture. In one embodiment, and as shown in FIG. 5, assisted steam delivery may also be used when generating gas bubbles. A boiler 22 is used to generate steam and steam 23 is added to the pressurized air prior to its introduction into the gas bubble generator vessel 16. The use of steam can be particularly advantageous since the steam can significantly enhance the convective transport of the kerosene/Brij® 72 mixture to the water-gas interface, and can also promote the formation of gas bubbles that are significantly smaller, thereby enhancing their interaction and collision opportunities with dispersed bitumen droplets in the aqueous slurry.

The air/steam/kerosene/Brij® 72 mixture is then introduced into a container containing an oil-containing slurry from which recovery of oil is desirable via nozzle 25. The container can take various different shapes, which can include, but are not limited to, various sized vessels, pipes and/or tubes. In FIG. 5, the container is a pipeline loop 10 containing aqueous oil sand slurry. The coated bubbles 24 are formed when the air/steam/kerosene/Brij® 72 mixture in the gas bubble generator vessel 16 is injected into the aqueous slurry present in pipeline 10 via nozzle 25, where the coated bubbles attach to the bitumen flecks present in the oil sand slurry. The so-conditioned slurry is then transported to a separation vessel 26 where the bitumen attached to the coated bubbles floats to the top of the vessel 26 and removed as bitumen froth.

In operation, the method of the present invention can be used to recover high yields of bitumen from aqueous oil sand slurries. In such an embodiment, the container of the system for recovering oil is filled with an aqueous slurry of oil sand. As discussed above, the container may take various forms, including, but not limiting to, pipes, through which the aqueous slurry may be pumped. An air stream and a separate stream of a mixture of sufficient amounts of the hydrophobic coating agent and the coating promoting additive are both fed into the gas bubble generator where mixing can occur. If desired, steam may also be introduced into the air stream prior to its introduction into the gas bubble generator. The air/steam/hydrophobic coating agent/coating promoting additive mixture is then introduced into the slurry via an injection nozzle, perforated pipe or the like, at which point coated gas bubbles are formed in the slurry. The coated gas bubbles can readily attach to the bitumen droplets present in the aqueous oil sand slurry.

Once the bitumen attaches to the coated gas bubbles, the bitumen may be recovered by using a number of gravity separation techniques such as using a quiescent PSV. The bitumen/gas bubble will rise to the surface of the PSV and take the form of bitumen froth, from which bitumen or other petroleum-like hydrocarbons can be recovered.

In another embodiment, coated air bubbles can be directly added to a container such as a vessel, which houses the aqueous oil sand slurry. The bitumen/gas bubble with then float to the top of the vessel, forming a bitumen froth, which can then be separated from the water and solids contained in the slurry.

### EXAMPLE 1

### Recovery of Bitumen from Aqueous Oil Sand Slurry

Tests were performed using the experimental test system shown in FIG. 5 except steam was not added. Coated bubbles of the present invention were formed using air mixed with atomized kerosene at a volume ratio of kerosene to air of about 500 ppm and about 1000 ppm Brij® 72 (Brij® 72 in kerosene, by mass). The air/kerosene/Brij® 72 mixture was injected through a nozzle into the pipeline containing aqueous oil sand slurry at a rate of about 200 mL/min. The aqueous oil sand slurry typically comprises a ratio of bitumen/water/solids of about 10/52/43. The aerated slurry was then placed into the gravity separation vessel where the aerated bitumen froth was allowed to float to the top. The percent bitumen recovered after various settling time intervals were measured using standard tests known in the art.

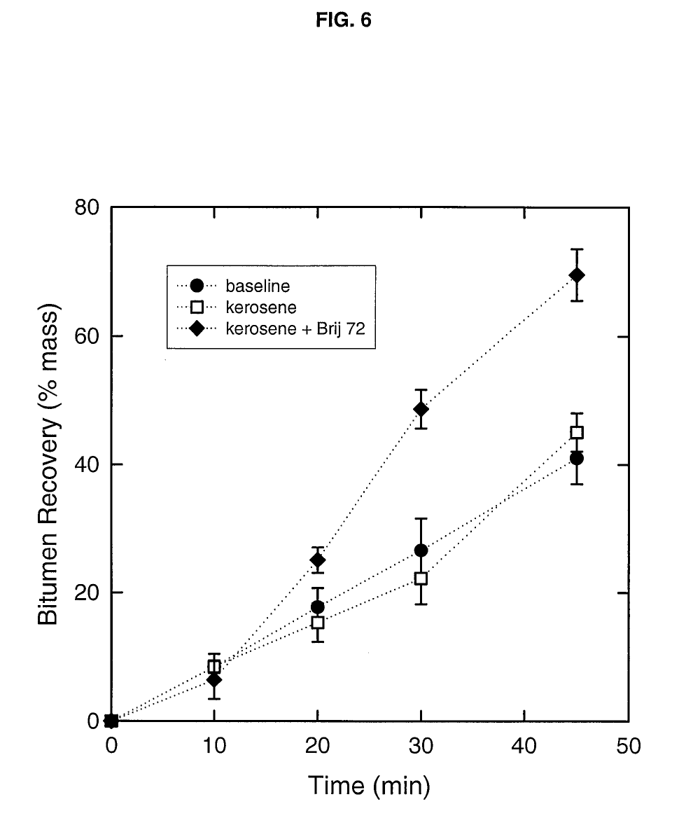

The test was repeated using air and atomized kerosene (500 ppm (vol) kerosene atomized in air) without the addition of Brij® 72 and with the addition of air alone. The results are shown in FIG. 6.

As can be seen in FIG. 6, after 45 minutes the relative bitumen recovery increased almost 75% over the baseline (air alone) and almost 55% over kerosene alone when coated air bubbles of the present invention were used. Furthermore, it can be seen from the slope of the line that the rate of bitumen recovery was noticeably enhanced when coated air bubbles of the present invention were used

### EXAMPLE 2

### Hydrophobic Coating Agent Wettability at an Air-Water Interface

To demonstrate the influence of various coating promoting additives on the hydrophobic coating agent's wettability (i.e., spreading coefficient) at an air-water interface (using kerosene as an example of a hydrophobic coating agent), the interfacial tensions of kerosene treated with three coating promoting additives, namely, Brij® 72 (HLB=4.9), Tetronic™ 701 (HLB=4) and Triton™ SP-135 (HLB=8), were evaluated against commercial process water (CPW) routinely used in oil sand extraction and air. These data were then used to evaluate the spreading coefficient of the treated kerosene at the air-water interface using the following equation:
S=σ_{w}−(σₕ+σ_{hw})
whereby σ_{w} and σₕ are the surface tensions of water and hydrocarbon, respectively, and σ_{hw} is the interfacial tension between the hydrocarbon and water.

Without being bound to theory, it is believed that, as a balance between the cohesive force of kerosene and the adhesion force between kerosene and water, a positive spreading coefficient (S>0) indicates that, in the present context, the oil phase will spontaneously spread onto the air-water interface. A negative spreading coefficient (S<0) means that cohesive forces of the hydrocarbon phase dominate and the oil will ‘ball up’ at the oil-water interface.

The interfacial tensions were measured using a maximum bubble pressure method (as described in Moran et al. (2000), Canadian Journal of Chemical Engineering, 78, 625-634, incorporated herein by reference), a minimum bubble pressure method (as described in Moran, K., and J. Czarnecki (2007) “Competitive Adsorption of Sodium Naphthenates and Naturally-Occurring Species at Water-in-Crude Oil Emulsion Droplet Surfaces”, Colloid and Surfaces A, 292(2-3), 87-98, incorporated herein by reference) and/or the wilhelmy plate method. With the exception of the minimum bubble pressure technique, these are well-known art and a brief description of each technique is given below.

Maximum and Minimum Bubble Pressure

With the conventional maximum bubble pressure method, a water-filled capillary tube (10 micron diameter) is immersed in the hydrocarbon phase and positive pressure is applied to force water through its tip. The (maximum) pressure at which a water droplet is spontaneously released from the micropipette tip, corresponding to a hemispherical interfacial geometry, is noted and the interfacial tension is calculated from the Young-Laplace equation. For surface tension measurements, the maximum pressure required to expel air, from within an air-filled capillary tube, into an aqueous or hydrocarbon phase is noted. The minimum bubble pressure technique involves capturing an individual emulsion droplet and applying negative pressure. The (minimum) pressure at which the droplet is spontaneously drawn into the capillary tube allows for interfacial tension calculation. An advantage of this method is that emulsions can be aged in situ for very long periods of time to track dynamic trends in the interfacial tension on a larger time scale. These techniques give consistent, reproducible measurements.

Wilhelmy Plate

A K100 interfacial tensiometer (Kruss GmbH, Hamburg, Germany) was used with a platinum Wilhelmy Plate (PL-01, Kruss GmbH) to measure both surface (against air) and interfacial (against water) tensions of the conditioned hydrocarbons. SV20 and SV10 sample vessels (Kruss GmbH) were used to house the liquids. A liquid's surface tension is created by the cohesive energy between the molecules on the surface of the liquid. The measurements are controlled via LabDesk 3.0 software for data acquisition and reduction. Confidence in the data was obtained through measurements of pure fluid systems. The used plates were cleaned by heat treatment at 760° C. in a Barnstead Thermolyne muffle furnace (type 30400, Barnstead International, Dubuque, Iowa) for one minute.

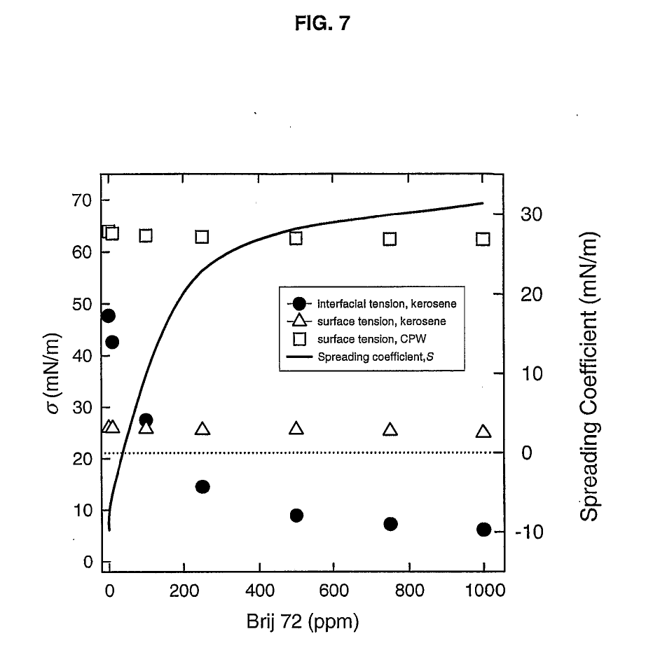

As can be seen from FIG. 7, the addition of the coating promoting additive Brij® 72 to the hydrophobic coating agent kerosene lowers the interfacial tension between kerosene and CPW. Further, FIG. 7 shows that the addition of Brij® 72 increases the spreading coefficient of the kerosene, thereby promoting the spreadability of the kerosene around a gas bubble. Thus, a continuous film of kerosene is formed around the gas bubble to form coated gas bubbles with a substantially complete or continuous coating.

The kerosene interfacial tension against water followed classical surfactant behaviour. Monolayer adsorption was observed up to a Brij® 72 concentration of about 100 ppm. Additional Brij® 72 did little to further reduce the kerosene-water interfacial tension above about 500 ppm concentration. The critical micelle concentration can be estimated by finding the intersection of the two relatively linear regions of the tension isotherm. For the kerosene-water system under investigation, the CMC is estimated at ˜200 ppm. It is interesting to note that the surface tensions are invariant to surfactant concentration; this suggests that Brij® 72 does not adsorb at the air-kerosene interface. Further, since Brij® 72 is insoluble in water, the surface tension of CPW was constant regardless of Brij® 72 concentration. Thus, from FIG. 7, it can be seen that kerosene alone (i.e., in the absence of Brij® 72) will not spread onto an air-water interface since the spreading coefficient is negative (S˜−10). It is estimated that the critical concentration of Brij® 72 (S=0) required for the spontaneous spreading of kerosene onto an air-water interface is about 50 ppm.

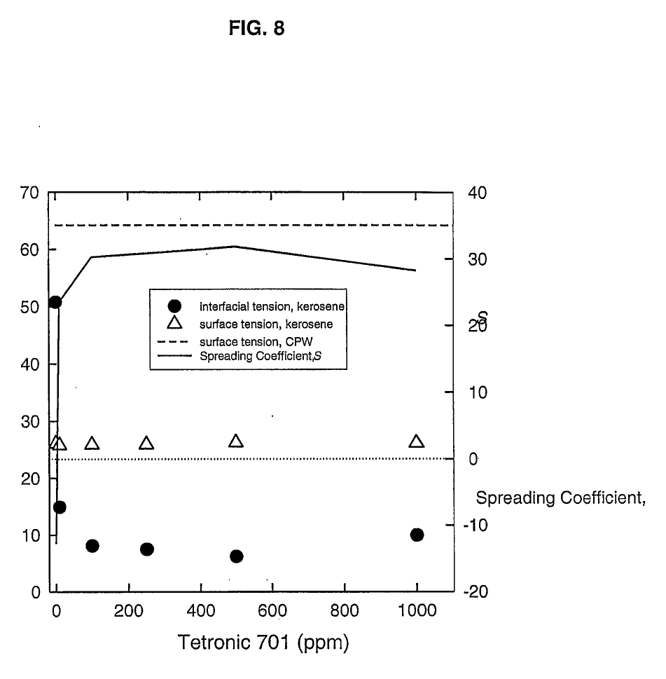

As can be seen in FIG. 8, another coating promoting additive, namely, Tetronic™ 701 gave similar adsorption characteristics as with Brij® 72. In particular, Tetronic™ 701 prefers to adsorb at the kerosene-water interface while showing almost no activity at the air-water interface. The CMC for Tetronic™ 701 in kerosene is estimated to be at about 50 ppm. Further, kerosene was shown to spontaneously wet an air-water interface at Tetronic™ 701 concentration between 10-50 ppm and, as such, may be somewhat more effective than Brij® 72. Due to the low water solubility for Tetronic™ 701, the surface tension measured for the commercial process water was taken as that utilized for the Brij® 72 spreading coefficient calculations.

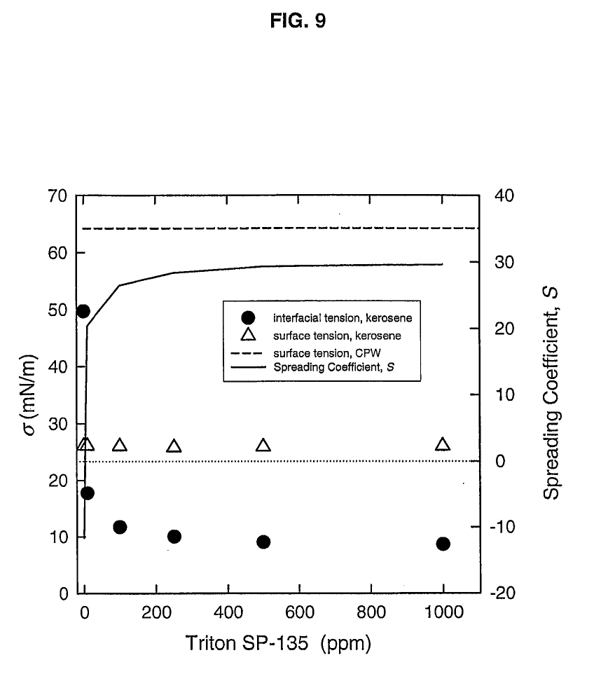

As can be seen in FIG. 9, similar trends were noted for kerosene-air-water systems in which the kerosene was treated with Triton™ SP-135. With a CMC of about 50 ppm, Triton™ SP-135 appear to be about as effective as Tetronic™ 701 in promoting the spontaneous wetting of kerosene onto an air water interface with a critical wetting concentration (S=0) ranging from 10-50 ppm.

In practice, any additive that reduces the hydrocarbon-water interfacial tension would work in promoting the wetting of kerosene onto an air bubble surface within an aqueous medium. While the spontaneous wettability, induced by the surfactant activity, is a necessary requirement for air bubbles to become effectively coated with the kerosene, auxiliary benefits may exist that may enhance bitumen-air attachment in a flotation process. Without being bound to theory, it is believed that the kerosene increases the fluid viscosity at the air bubble surface, thus retarding their coalescence and allowing for more time for bitumen contacting. Further, in reducing the hydrocarbon-water interfacial tension, the additive promotes the formation of relatively smaller air bubbles.

### EXAMPLE 3

### Kinetics of Kerosene Spreading

Kerosene spreading experiments were performed to directly assess the influence of coating promoting additives on the wettability of a hydrophobic coating agent droplet at an air bubble surface. The air bubble surface was simulated by placing approximately four milliliters of deionized water on a 75 mm by 50 mm precleaned plain microslide (model 2947, Corning Glass Works, Corning, N.Y.). The weight of the water created a near planar air-water surface onto which droplets of conditioned hydrophobic coating agent (i.e., kerosene plus Brij® 72, Tetronic™ 701 or Triton™ SP-135) could be placed. Individual droplets, of approximately 10-15 μL, were carefully placed onto the water surface using glass transfer pipette (model 450575, Assurance Dropper Corporation, Bracelton, Ga.) and the spreading behaviours were recorded using a video camera for subsequent analysis.

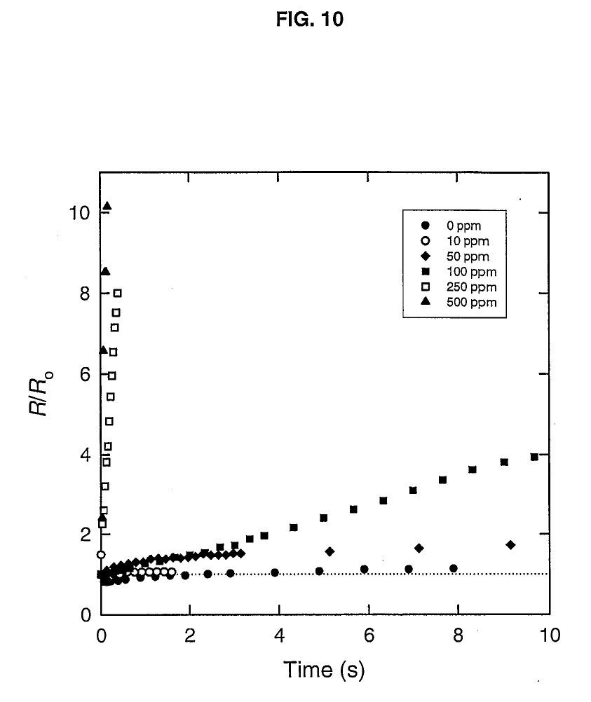

In particular, the kinetics of the kerosene spreading on the air-water interface was quantified to better identify critical concentrations of chemicals required for spontaneous wetting behaviour. The temporal evolution of the contact area could be determined from the video recording of the spreading experiment using image analysis software (Adobe). The spreading kinetics of kerosene treated with various concentrations of Brij® 72, ranging from 0 to 500 ppm, is shown in FIG. 10. The ordinate is scaled by the droplet radius Rₒ, the droplet radius observed as it is placed onto the water surface in a spreading experiment (at t=0 s). The R/Rₒ datum is shown as a dotted line.

Spontaneous spreading of kerosene onto an air-water interface is driven by the kerosene-air-water system's thermodynamics (equation 1). Thus, one would expect faster and/or more complete wetting as the spreading coefficient S increases. For untreated kerosene droplets, the contact area was constant at the initial value (t=0 s) over the period of the experiment since relative contact radius was invariant at R/Rₒ=1. At lower Brij® 72 concentrations (50 ppm or less), the kerosene exhibited minimal spreading behaviour as R/Rₒ reached a stable values of 1.05 (10 ppm Brij® 72) and 1.8 (50 ppm Brij 72). However, as the Brij® 72 concentration in kerosene was increased to 100 ppm, the wetting behaviour became more notable with R/Rₒ stabilizing at a value of about four, indicating that the contact area has increased 16 fold. At high Brij® 72 concentrations (greater than 100 ppm), the kerosene spreading is dramatically enhanced, as the relative radius increased to values greater than eight. Due to experimental constraints, only non-equilibrium R/Rₒ values were observed for kerosene treated with 250 ppm and 500 ppm of Brij 72.

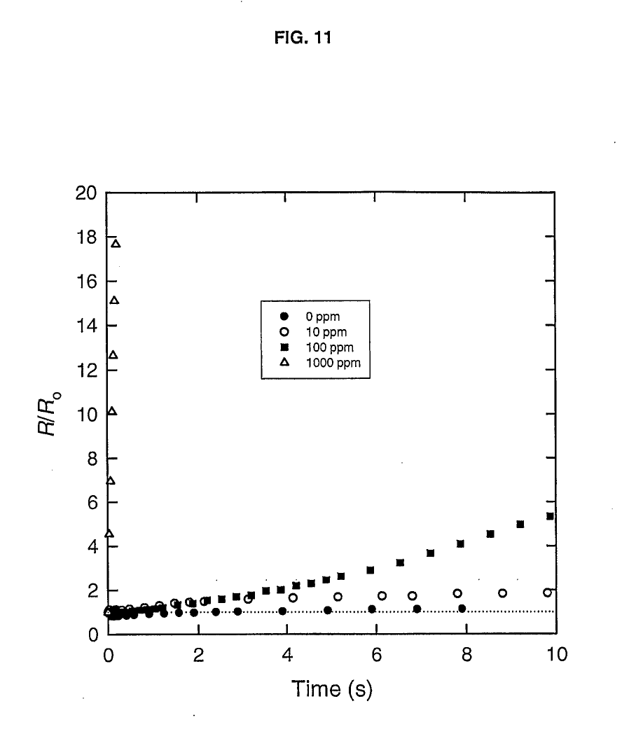

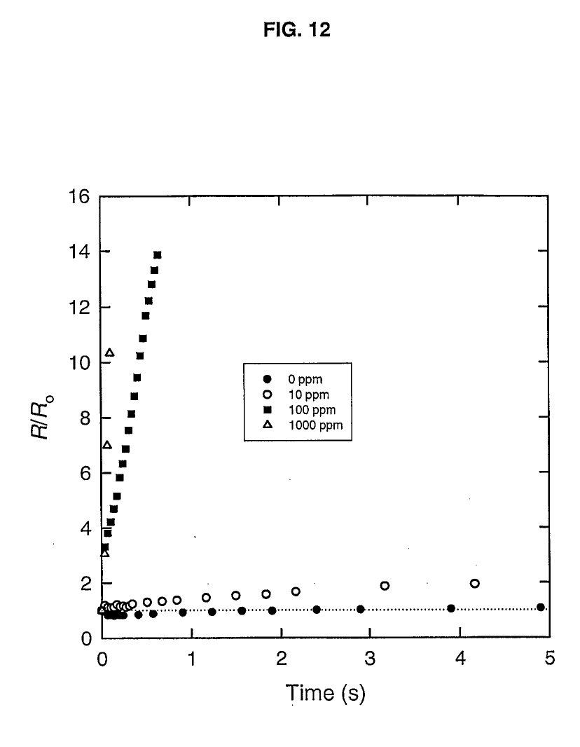

The above observations are consistent with the spreading coefficient calculations shown in FIG. 7, suggesting a critical Brij® 72 concentration of about 100 ppm. Also of importance is the noticeable increase in the spreading rate (d(R/Rₒ)/dt) as the concentration of Brij® 72 is increased above the apparent critical concentration. Similar analyses were conducted on spreading experiment data in which the kerosene was treated with Tetronic™ 701 (FIG. 11) and Triton™ SP-135 (FIG. 12).

With Tetronic™ 701 as the coating promoting additive, significant spreading was not observed until a concentration of 100 ppm was utilized (FIG. 11). As in FIG. 10, the ordinate of FIG. 11 is scaled by the droplet radius Rₒ, the droplet radius observed as it is placed onto the water surface in a spreading experiment (at t=0 s). The R/Rₒ datum is shown as a dotted line.

FIG. 11 shows that, at least relative to the systems treated with Brij® 72, some spreading did occur at Tetronic™ 701 concentrations as low as 10 ppm. This observation is consistent with the spreading coefficient calculation (FIG. 8). Due to the somewhat enhanced activity of Tetronic™ 701 in reducing the kerosene-water interfacial tension (relative to Brij® 72), one would expect to observe more spreading at lower Tetronic™ 701 concentrations.

Turning now to FIG. 12, once again, the ordinate is scaled by the droplet radius Rₒ, the droplet radius observed as it is placed onto the water surface in a spreading experiment (at t=0 s). The R/Rₒ datum is shown as a dotted line. While it was observed that kerosene somewhat wetted the air-water interface at low Triton™ SP-135 (10 ppm) concentrations, significant spreading occurred at concentrations of 100 ppm or greater.

It is understood that the choice of coating promoting additive can affect both the extent (R/Rₒ) and the rate (d(R/Rₒ)/dt) of kerosene spreading on the air-water interface. Both aspects should be considered for potential applications to novel bitumen aeration technologies.

Table 1 lists examples of surfactants useful as coating promoting additives in the present invention.

TABLE 1
Surfactants Useful As Coating Promoting Additives

| Name | Chemical Structure | HLB |
|---|---|---|
| SPAN ™ 20 | Sorbitan monolaurate | 8.6 |
| SPAN ™ 40 | Sorbitan monopalmitate | 6.7 |
| SPAN ™ 60 | Sorbitan monostearate | 4.7 |
| SPAN ™ 65 | Sorbitan tristearate | 2.1 |
| SPAN ™ 80 | Sorbitan monoleate | 4.3 |
| SPAN 85 | Sorbitan trioleate | 1.8 |
| ARLACEL ™ 60 | Sorbitan monostearate | 4.7 |
| ARLACEL ™ 83 | Sorbitan sequioleate | 3.7 |
| BRIJ ® 52 | Polyoxyethylene(2) cetylether | 5.3 |
| BRIJ ® 93 | Polyoxyethylene(2) oleylether | 4.9 |
| BRIJ ® 72 | Polyoxyethylene(2) stearylether | 4.9 |
| ATSURF ™ 2802 | Butylated hydroxyanisole | 3.5 |
| TRITON ™ SP-135 | | 8.0 |
| TRITON ™ X-15 | Octylphenoxypolyethyoxyethanol | 3.6 |
| TETRONIC ™ 701 | block copolymers of EO & PO | 4.0 |
| TETRONIC ™ 702 | same as above | 7.0 |
| TETRONIC ™ 901 | same as above | 2.5 |
| TETRONIC ™ 50R4 | same as above | 8.9 |
| TETRONIC ™ 70R2 | same as above | 4.8 |
| TETRONIC ™ 70R4 | same as above | 7.9 |
| TETRONIC ™ 90R4 | same as above | 7.1 |
| TETRONIC ™ 150R4 | same as above | 5.4 |
| TETRONIC ™ 70R1 | same as above | 2.9 |
| TETRONIC ™ 90R1 | same as above | 2.4 |
| TETRONIC ™ 110R1 | same as above | 1.9 |
| TETRONIC ™ 130R1 | same as above | 1.4 |
| TETRONIC ™ 1502 | same as above | 5.0 |
| PLURONIC ™ 25R1 | block copolymers of PO & EO | 4.0 |
| PLURONIC ™ L35 | same as above | 8.0 |
| PLURONIC ™ L62D | same as above | 7.0 |
| PLURONIC ™ L72 | same as above | 6.5 |
| PLURONIC ™ L101 | same as above | 1.0 |
| PLURAFAC ™ RA40 | Linear alcohol alkoxylates | 7.0 |
| PLURAFAC ™ A-24 | same as above | 5.0 |
| IGEPAL ™ CA-210 | octylphenoxylpoly(EO) ethanol | 3.5 |
| IGEPAL ™ CA-420 | same as above | 8.0 |
| IGEPAL ™ CO-210 | Nonylphenoxypoly(EO) ethanol | 4.6 |

While the invention has been described in conjunction with the disclosed embodiments, it will be understood that the invention is not intended to be limited to these embodiments. On the contrary, the current protection is intended to cover alternatives, modifications and equivalents, which may be included within the spirit and scope of the invention. Various modifications will remain readily apparent to those skilled in the art.

What is claimed is:

1. A method for forming gas bubbles coated with a hydrophobic coating agent in an aqueous environment, comprising:
(a) providing a gas stream;
(b) injecting the hydrophobic coating agent and a coating promoting additive into the gas stream to form an air, hydrophobic coating agent and coating promoting additive mixture; and
(c) introducing the mixture into the aqueous environment and forming the coated gas bubbles.

2. The method of claim 1 further comprising adding steam to the gas stream.

3. The method of claim 1, wherein the hydrophobic coating agent and the coating promoting additive are injected into the gas stream as a colloidal dispersion by means of an atomizing nozzle.

4. The method of claim 1, wherein the hydrophobic coating agent is a hydrocarbon or an inorganic or polymeric agent that acts as a hydrocarbon.

5. The method of claim 1, wherein the hydrophobic coating agent is selected from the group consisting of kerosene, diesel, naphtha, and mixtures thereof.

6. The method of claim 1, wherein the coating promoting additive is oil soluble.

7. The method of claim 1, wherein the coating promoting additive is a lipophilic surfactant having a hydrophile-lipophile balance of less than 9.

8. The method of claim 1, wherein the coating promoting additive is selected from the group consisting of Brij® 72, Tetronic™ 701, Triton™ SP-135, or mixtures thereof.

9. A method for recovering oil from an oil-containing sample, comprising:
(a) introducing into the oil-containing sample a plurality of gas bubbles having a coating comprising a hydrophobic coating agent and a coating promoting additive;
(b) allowing the oil to interact with the coated gas bubble to form an oil-gas bubble complex; and
(c) separating the oil-gas bubble complex from the remainder of the sample to form an oily froth;
wherein the coating promoting additive is present in an amount sufficient to promote the substantially continuous coating of the gas bubbles with the hydrophobic coating agent.

10. The method of claim 9, wherein the coating promoting additive is present in an amount sufficient to reduce the interfacial tension between the hydrophobic coating agent and any water present in the sample.

11. The method of claim 9 wherein the coating promoting additive is selected from the group consisting of Brij® 72, Tetronic™ 701, Triton™ SP-135, or mixtures thereof.

12. The method of claim 9 wherein the hydrophobic coating agent is a hydrocarbon or an inorganic or polymeric agent that acts as a hydrocarbon.

13. The method of claim 12, wherein the hydrophobic coating agent is a hydrocarbon.

14. The method of claim 13, wherein the hydrocarbon is selected from the group consisting of kerosene, diesel, naphtha and mixtures thereof.

15. The method of claim 10, wherein the gas is air or an inert gas such as nitrogen or argon.

16. A system for recovering oil from an oil-containing sample, the system comprising:
(a) a container for housing the oil-containing sample;
(b) a gas bubble generator for generating a plurality of gas bubbles having a coating, the coating comprising a hydrophobic coating agent and a coating promoting additive; and
(c) means for introducing the plurality of coated gas bubbles into the container.

17. The system of claim 16, wherein the gas bubble generator comprises an atomizing nozzle or perforated pipe.

18. The system of claim 16, wherein the gas bubble generator further comprises a means for introducing steam to facilitate the formation of small coated gas bubbles.

19. The system of claim 16, wherein the container is selected from the group consisting of vessels, pipes and tubes.

20. A coated gas bubble for recovering oil from oil-containing samples, comprising:
(a) a gas bubble; and
(b) a coating mixture comprising a hydrophobic coating agent and a coating promoting additive;
whereby the coating promoting additive is present in an amount sufficient to promote the substantially continuous coating of the gas bubble with the hydrophobic coating agent.

21. The coated gas bubble as claimed in claim 20, wherein the hydrophobic coating agent is a hydrocarbon or an inorganic or polymeric agent that acts as a hydrocarbon.

22. The coated gas bubble as claimed in claim 20, wherein the hydrophobic coating agent is selected from the group consisting of kerosene, diesel, naphtha, and mixtures thereof.

23. The coated gas bubble as claimed in claim 20, wherein the coating promoting additive is a lipophilic surfactant having a hydrophile-lipophile balance of less than 9.

24. The coated gas bubble as claimed in claim 20, wherein the coating promoting additive is selected from the group consisting of Brij® 72, Tetronic™ 701, Triton™ SP-135, or mixtures thereof.
